(19) United States
(12) Patent Application Publication
(10) Pub. No.: US 2025/0115036 A1
(43) Pub. Date: Apr. 10, 2025

(54) STRETCHABLE LAMINATE, METHOD FOR MANUFACTURING THE SAME, AND ELECTRONIC DEVICE INCLUDING THE SAME

(71) Applicant: Panasonic Intellectual Property Management Co., Ltd., Osaka (JP)

(72) Inventor: Kyosuke MICHIGAMI, Tokushima (JP)

(73) Assignee: Panasonic Intellectual Property Management Co., Ltd., Osaka (JP)

(21) Appl. No.: 18/904,813

(22) Filed: Oct. 2, 2024

(30) Foreign Application Priority Data
Oct. 6, 2023 (JP) 2023-174651

(51) Int. Cl. B32B 27/30; B32B 27/26; B32B 37/10

(52) U.S. Cl. CPC B32B 27/302; B32B 27/26; B32B 37/10; B32B 2250/03; B32B 2307/308; B32B 2307/51; B32B 2307/54; B32B 2457/08

(57) ABSTRACT

The present invention relates to a stretchable laminate that is a laminate including: a resin layer (A); a first substrate (B); and a second substrate (C), wherein the resin layer (A) includes a cured product of a resin composition including an organic peroxide, the resin layer (A) is located between the first substrate (B) and the second substrate (C), the resin layer (A) has a tensile stress of 0.5 MPa or more and 10 MPa or less at 50% elongation, and an elongation at break of 50% or more and 700% or less, and when a surface of the resin layer (A) is observed with an optical microscope, a total number of bubbles and openings having a diameter of 150 to 500 μm is 5 per 10 cm² or less, and bubbles and openings having a diameter exceeding 500 μm are not present.

### FIELD OF INVENTION

The present invention relates to a stretchable laminate, a method for manufacturing the same, and an electronic device including the same.

### BACKGROUND ART

As the information processing quantity by various kinds of electronic equipment increases, mounting technologies such as high integration of semiconductor devices to be mounted, densification of wiring, and multilayering are progressing. In addition, wiring boards to be used in various kinds of electronic equipment are required to be, for example, high-frequency compatible wiring boards such as a millimeter-wave radar board for in-vehicle use. Wiring boards to be used in various kinds of electronic equipment are required to decrease the loss during signal transmission in order to increase the signal transmission speed, and this is especially required for high-frequency wiring boards. To meet this requirement, substrate materials for forming wiring substrates to be used in various types of electronic equipment are required to have a low dielectric constant and a low dielectric loss tangent.

As such a substrate material, for example, a resin composition including polyphenylene ether (PPE) and an elastomer such as a styrene butadiene copolymer has been reported (JP 2018-95815 A and JP 2000-104038 A).

The techniques disclosed in JP 2018-95815 A and JP 2000-104038 A are substrate materials superior in low dielectric properties. On the other hand, with the development of the electronics field in recent years, electronic equipment and the like may be required to have, in addition to the requirement for the characteristics as described above, a flexible device that can be freely deformed or bent in order to be disposed on a curved surface, an uneven surface, or the like according to the application. However, the materials disclosed in the above-mentioned documents are not stretchable materials.

JP 2018-95815 A and JP 2000-104038 A describe use of a radical polymerization initiator such as an organic peroxide as a curing accelerator, but when a cover layer for blocking oxygen is provided at the time of producing a film or the like by curing a resin composition containing an organic peroxide or the like, a peroxide gas is generated to form bubbles, which may lead to poor appearance. In addition, when bubbles or openings are present on the surface of the substrate material, defects such as pinholes may occur at the time of applying and printing a conductive layer or performing patterning depending on the size of number of the bubbles or openings.

The present invention has been devised in view of such circumstances, and an object thereof is to provide a stretchable laminate having flexibility and stretchability and having a resin layer having a reduced number of bubbles or openings.

### SUMMARY OF THE INVENTION

As a result of intensive studies, the present inventor has found out that the problems can be solved by the following configuration, and completed the present invention by conducting further studies based on this finding.

That is, a stretchable laminate according to one aspect of the present invention is a laminate including: a resin layer (A); a first substrate (B); and a second substrate (C), wherein the resin layer (A) includes a cured product of a resin composition including an organic peroxide, the resin layer (A) is located between the first substrate (B) and the second substrate (C), the resin layer (A) has a tensile stress of 0.5 MPa or more and 10 MPa or less at 50% elongation, and an elongation at break of 50% or more and 700% or less, and when a surface of the resin layer (A) is observed with an optical microscope, a total number of bubbles and openings having a diameter of 150 to 500 μm is 5 per 10 cm² or less, and bubbles and openings having a diameter exceeding 500 μm are not present.

A method for manufacturing a stretchable laminate according to another aspect of the present invention is a method for manufacturing the laminate as described above, the method including: laminating the resin layer (A), the first substrate (B), and the second substrate (C), and heating these under pressurization, wherein a pressure during the pressurization is 0.3 MPa or more and 10 MPa or less.

### BRIEF DESCRIPTION OF THE DRAWINGS

FIG. 1 is a schematic sectional view of a stretchable laminate according to one embodiment of the present invention.

FIG. 2 is a schematic view illustrating bubbles and openings observed from a surface of the resin layer (A) in the present embodiment.

FIGS. 3A to 3E are schematic sectional views illustrating a process of manufacturing the stretchable laminate according to one embodiment of the present invention.

### DETAILED DESCRIPTION

Hereinafter, a specific embodiment of the present invention will be described, but the embodiment described below is merely one of various embodiments of the present invention. The following embodiment can be modified in various ways depending on the design as long as the object of the present invention can be achieved.

### (Stretchable Laminate)

First, the configuration of the stretchable laminate of the present embodiment will be specifically described. In the following description, reference numerals denote 1: resin layer (A), 1′: resin layer (A′), 2: first substrate (B), 3: second substrate (C), and 10: stretchable laminate.

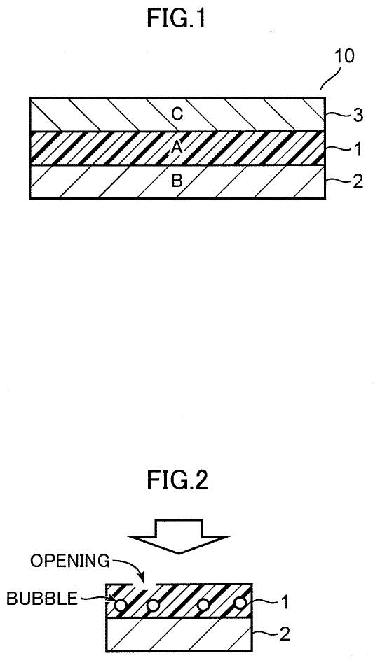

As illustrated in FIG. 1, the stretchable laminate 10 of the present embodiment includes a resin layer (A) 1, a first substrate (B) 2, and a second substrate (C) 3. The resin layer (A) 1 is provided between the first substrate (B) 2 and the second substrate (C) 3, and includes a cured product of a resin composition including an organic peroxide. The resin layer (A) 1 has a tensile stress of 0.5 MPa or more and 10 MPa or less at 50% elongation, and an elongation at break of 50% or more and 700% or less. Further, when a surface of the resin layer (A) is observed with an optical microscope, the total number of bubbles and openings having a diameter of 150 to 500 μm is 5 per 10 cm² (5/10 cm²) or less, and bubbles and openings having a diameter exceeding 500 μm are not present.

With such a configuration, a laminate having flexibility and stretchability and having reduced bubbles and openings is obtained. In addition, by controlling the bubbles and openings on the surface of the resin layer (A) as described above, it is possible to inhibit not only the poor appearance but also the occurrence of defects such as pinholes when a conductive layer is applied, printed, or patterning is performed. As a result, it is possible to prevent defects that occur at the time of forming a circuit or the like. Therefore, the stretchable laminate of the present embodiment can be suitably used particularly in applications such as stretchable electronic devices.

### Resin Layer (A)

The resin layer (A) of the present embodiment includes a cured product of a resin composition including an organic peroxide. As the organic peroxide, an organic peroxide that can be used as a radical polymerization initiator can be used without particular limitation. When no organic peroxide is contained, the resin layer (A) is not cured and is melted, so that it is difficult to prepare a resin layer or sufficient heat resistance cannot be obtained.

Specifically, examples of the organic peroxide of the present embodiment include α,α′-di(t-butylperoxy)diisopropylbenzene, 1,1-di(t-hexylperoxy)cyclohexane, 2,5-dimethyl-2,5-di(t-butylperoxy)-3-hexyne, benzoyl peroxide, 3,3′,5,5′-tetramethyl-1,4-diphenoquinone, chloranil, 2,4,6-tri-t-butylphenoxyl, t-butylperoxyisopropyl monocarbonate, azobisisobutyronitrile, methyl ethyl ketone peroxide, acetylacetone peroxide, 1,1-di(t-butylperoxy)cyclohexane, 2,2-di(t-butylperoxy)butane, n-butyl 4,4-di-(t-butylperoxy)valerate, 2,2-di(4,4-di-(t-hydroxyperoxide, diisopropylbenzene butylperoxy) cyclohexyl) propane, p-menthane hydroxyperoxide, cumene hydroperoxide, t-butyl hydroperoxide, di(2-t-butylperoxyisopropyl)benzene, dicumyl peroxide, 2,5-dimethyl-2,5-di(t-butylperoxy)hexane, t-butyl cumyl peroxide, di-t-butyl peroxide, 2,5-dimethyl-2,5-di(t-butylperoxy)hexyne, diisobutyl peroxide, di(3,5,5-trimethylhexanoyl)peroxide, dilauroyl peroxide, succinoyl peroxide, di-(3-methylbenzoyl)peroxide, benzoyl (3-methylbenzoyl)peroxide, dibenzoyl peroxide, di-n-propyl peroxydicarbonate, diisopropyl peroxycarbonate, di(4-t-butylcyclohexyl)peroxycarbonate, di(2-ethylhexyl)peroxydicarbonate, di-sec-butyl peroxydicarbonate, cumyl peroxyneodecanoate, 1,1,3,3-tetramethylbutyl peroxyneodecanoate, t-hexyl peroxyneodecanoate, t-butyl peroxyneodecanoate, t-hexyl peroxypivalate, 1,1,3,3-tetramethylbutyl peroxy-2-ethylhexanoate, 2,5-dimethyl-2,5-di(2-ethylhexanoylperoxy)hexane, t-butyl peroxy-2-ethylhexanoate, t-hexyl peroxyisopropylmonocarbonate, t-butyl peroxy-3,5,5-trimethylhexanoate, t-butyl peroxylaurate, t-butyl peroxyisopropylmonocarbonate, t-butyl peroxy-2-ethylhexylmonocarbonate, t-hexyl peroxybenzoate, 2,5-dimethyl-2,5-di(benzoylperoxy)hexane, t-butyl peroxyacetate, t-butyl peroxy-3-methylbenzoate, t-butyl peroxybenzoate, t-butyl peroxyallylmonocarbonate, and 3,3′,4,4′-tetra(t-butylperoxycarbonyl)benzophenone.

The resin component in the resin composition to be used for the resin layer (A) is not particularly limited as long as it is a resin component that a cured product of the resin composition has a tensile stress of 0.5 MPa or more and 10 MPa or less at 50% elongation and an elongation at break of 50% or more and 700% or less. As such a resin component, it is preferable that, for example, an elastomer having a melting point of 70° C. or higher is contained. Thereby, heat resistance in the cured product is obtained, and the resin hardly flows out during heat molding, so that the film thickness can be easily controlled. In addition, since the loss of the resin is reduced, there is an advantage that manufacturing efficiency is improved.

Examples of the elastomer specifically include a styrenic copolymer, an acrylic polymer, a silicone-based polymer, polyester, polyurethane, polyolefin, and polyamide. Among them, a styrenic copolymer is preferably used from the viewpoint of obtaining low dielectric properties, stretch followability, adhesion to materials, and the like.

Examples of the styrenic copolymer include a styrene butadiene styrene copolymer, a methylstyrene (ethylene/butylene) methylstyrene copolymer, a methylstyrene (ethylene-ethylene/propylene) methylstyrene copolymer, a styrene isoprene copolymer, a styrene isoprene styrene copolymer, a styrene (ethylene/butylene) styrene copolymer, a styrene ethylene copolymer, a styrene (ethylene-ethylene/propylene) styrene copolymer, a styrene (butadiene/butylene) styrene copolymer, a styrene isobutylene styrene copolymer, and hydrogenated products of these copolymers. The hydrogenated products may be either partially hydrogenated or completely hydrogenated. As the styrenic copolymer, those recited as examples above may be used singly or two or more thereof may be used in combination. From the viewpoint of reactivity, unhydrogenated or partially hydrogenated products are preferable. These are advantageous in that their high reactivity can reduce the loss of the resin. In addition, from the viewpoint of thermal stability of the cured product, a completely hydrogenated product, a partially hydrogenated product, and an unhydrogenated product are preferred in descending order, and from the viewpoint of achieving both reactivity and thermal stability, a partially hydrogenated product is most preferred.

When the resin composition of the present embodiment comprises the styrenic copolymer and the organic peroxide, the blending ratio thereof is preferably 99.9:0.1 to 95.0:5.0 in mass ratio. The inclusion in such a blending ratio is advantageous in that the resin can be cured and heat resistance can be imparted. The blending ratio is more preferably 99.5:0.5 to 90.0:10.0. The inclusion in such a blending ratio is advantageous in that the loss of the resin during the curing thereof can be further inhibited and outgassing during use is reduced.

The resin composition of the present embodiment may contain components other than the components described above (other components), as necessary, as long as the effects of the present invention are not impaired. As such other components contained in the resin composition according to the present embodiment, for example, additives such as an inorganic filler, a curing agent, a silane coupling agent, a flame retardant, an antifoaming agent, an antioxidant, a heat stabilizer, an antistatic agent, an ultraviolet absorber, a dye or a pigment, a leveling agent, an adhesion improver, a dispersant, and a lubricant may be further contained.

Besides the elastomer as described above, the resin composition of the present embodiment may comprise other resin components, such as a polybutadiene resin, a polyphenylene ether resin, an epoxy resin, a maleimide resin, a polysiloxane resin, and an acrylic resin.

The mechanical strength can be adjusted by blending these resins. For example, when a polyphenylene ether resin, an epoxy resin, or a maleimide resin is used, there is an advantage that the tensile stress of the resin can be enhanced, the required blending amount of the organic peroxide can be reduced, and bubbles are hardly generated. The epoxy resin is preferable because an initiator other than organic peroxides such as imidazoles can also be used and the use of the epoxy resin in combination can improve the resin strength and can reduce the organic peroxide. The polysiloxane resin can reduce the tensile stress of the resin, and can produce a flexible laminate. The polysiloxane resin is also a component that can be cured with an initiator other than the organic peroxide, and has an advantage that bubbles can be reduced. There is an advantage that addition of the polybutadiene resin can enhance the tensile stress. Similarly to the epoxy resin and the polysiloxane resin, the polybutadiene resin can also improve the mechanical strength without increasing the blending amount of the necessary organic peroxide. When the resin composition comprises the polybutadiene resin, the blending ratio (mass ratio) of other resin component to the polybutadienes in the resin composition is preferably 100.0:0 to 75.0:25.0, and more preferably 95.0:5.0 to 80.0:20.0. Within this range, the flow out of the resin at the time of resin curing is reduced, and the stretchable laminate is easily manufactured.

Furthermore, in addition to the components described above, a reactive diluent such as a styrene monomer, an epoxy monomer, an acrylic monomer, or an α-olefin may also be contained in the resin composition of the present embodiment.

The resin layer (A) of the present embodiment includes a cured product of the resin composition as described above, and has a tensile stress of 0.5 MPa or more and 10 MPa or less at 50% elongation, and an elongation at break of 50% or more and 700% or less.

In the present embodiment, the elongation at break refers to the elongation percentage until fracture, and is an index indicating the flexibility of the resin layer (A). A more preferable elongation at break is 100% or more and 500% or less.

A laminate including the resin layer (A) having an elongation at break within the range described above exhibits high followability when deformed into an arbitrary shape, and therefore when the laminate of the present embodiment is used as a stretchable circuit board material, it is considered that, for example, a circuit board that exhibits superior followability to clothing or the like, is less likely to be fractured, and exhibits superior stretchability can be obtained.

The elongation at break of the present embodiment is a value measured by the following method.

First, a cured product of the resin composition to constitute the resin layer (A) is cut into a size 6 dumbbell (JIS K 6251, 2017) and attached to a universal testing machine (AGS-X manufactured by Shimadzu Corporation). Then, a test is conducted at room temperature (25° C.) and a tensile speed of 25 mm/min, and the elongation percentage when the cured product is fractured is measured with the tester and taken as “elongation at break”.

The tensile stress at 50% elongation of the resin layer (A) refers to a tensile stress when the elongation percentage reaches 50% in the tensile test described above, and is an index indicating the flexibility of the resin layer (A) together with the elongation at break described above. Within the range described above, high followability is exhibited at the time of deformation into an arbitrary shape, and therefore there is an advantage that when the laminate of the present embodiment is used as a stretchable circuit board material or the like, wirings and component mounted portions are less likely to be fractured. A more preferable range of the tensile stress is 1.0 MPa or more and 5 MPa or less.

In the present embodiment, the tensile stress is a value measured by the following method.

In the same manner as in the measurement of the elongation at break described above, a cured product of the resin composition to constitute the resin layer (A) is cut into a size 6 dumbbell (JIS K 6251, 2017) and attached to a universal testing machine (AGS-X manufactured by Shimadzu Corporation). Then, a test is conducted at room temperature (25° C.) and a tensile speed of 25 mm/min, and a stress value when the tensile elongation percentage reaches 50% is calculated.
Stress (G)=F/(d·l) (F is test force, d is film thickness, and l is width of test piece)

Since the resin composition constituting the resin layer (A) in the present embodiment comprises an organic peroxide, when the resin composition is cured, the organic peroxide is cleaved by heat to generate outgas, and bubbles and/or openings are generated in the cured product of the resin composition.

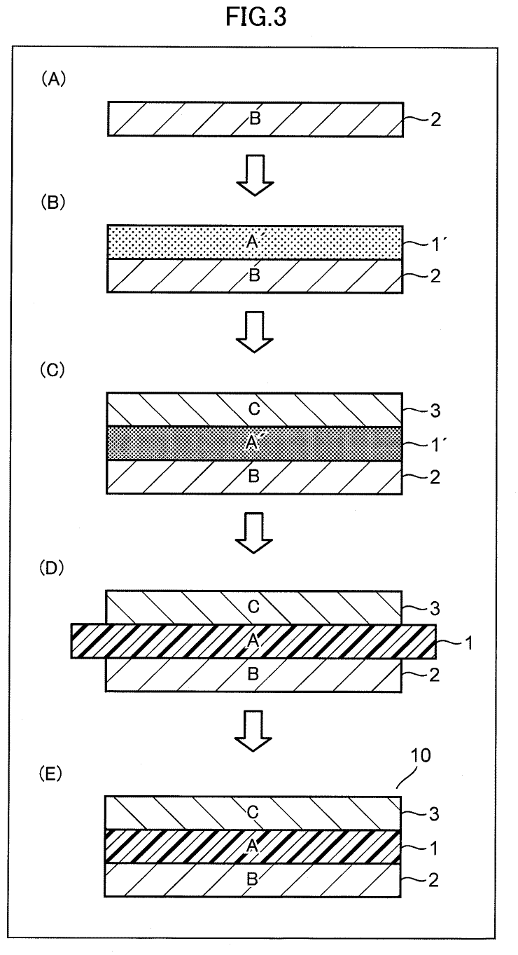

In the present embodiment, the “bubble” means an air bubble present in the resin layer (A) as illustrated in FIG. 2, and the “opening” refers to an opening located on the surface of the resin layer (A) as illustrated in FIG. 2. In particular, bubbles and openings on or near the surface of the resin layer (A) impair the appearance, and further cause pinholes and the like when a conductive layer is further formed on the laminate, and thus the stretchable laminate of the present embodiment is characterized in that when the surface of the resin layer (A) is observed with an optical microscope, a total number of bubbles and openings having a diameter of 150 to 500 μm is 5 per 10 cm² or less, and bubbles and openings having a diameter exceeding 500 μm are not present. In a more preferred embodiment, the total number of the bubbles and the openings having a diameter of 150 to 500 μm is 1 per 10 cm² ( 1/10 cm²) or less.

A method for observing and measuring the bubbles and the openings on the surface of the resin layer (A) of the stretchable laminate is performed with an optical microscope. Specifically, first, the first substrate (B) and/or the second substrate (C) is peeled off or removed, so that it is made possible to observe the resin layer (A) from the surface thereof.

The “surface” to be observed in the resin layer (A) may be either the first substrate (B) side or the second substrate (C) side, but it is preferably a surface on a side on which a conductive layer is formed by screen printing or the like, or patterning is performed by photolithography, laser processing or the like (a side on which a circuit is formed). When circuits are formed on both surfaces of the resin layer (A), it is preferable to perform observation on both the surfaces of the resin layer (A). Furthermore, when the thickness of the resin layer is large, or when the resin layer is colored, observation from one side is insufficient, and therefore it is preferable to perform observation from both the front and back sides.

When the first substrate (B) and/or the second substrate (C) is a film substrate such as a release film, the surface of the resin layer (A) is observed after peeling. When the first substrate (B) and/or the second substrate (C) is a metal foil, the metal foil is removed by etching or the like, and then the surface of the resin layer (A) is observed. In any case, more specifically, observation and measurement can be performed by the method described in Examples described later.

In the stretchable laminate of the present embodiment, the thickness of the resin layer (A) may be appropriately set depending on the application and the like of the laminate, and is, for example, about 0.01 mm or more and 1 mm or less. Furthermore, the thickness of the resin layer (A) is preferably 0.02 mm or more and 0.2 mm or less. When the thickness is smaller than that, the handleability is deteriorated, and the strength of the resin layer is also deteriorated. On the other hand, when the thickness is larger than that, bubbles are likely to be generated, and the resin layer is hard and flexibility as a device deteriorates.

### First Substrate (B) and Second Substrate (C)

In the present embodiment, one of the first substrate (B) and the second substrate (C) is laminated on one surface of the resin layer (A), and the other is laminated on the other surface of the resin layer (A). The first substrate (B) and the second substrate (C) may be the same or different and may be any one of a film supporting substrate, a metal foil, a release film, and the like.

The first substrate (B) is not particularly limited, but is preferably a substrate having a melting point of 250° C. or higher. Thereby, a curing reaction of the resin layer (A) can be appropriately carried out without allowing the substrate to exhibit deformation or the like even under the thermal condition for curing the resin layer (A).

For the same reason, the second substrate (C) is also not particularly limited, but is preferably a substrate having a melting point of 250° C. or higher.

The film supporting substrate or the release film that can be used is not particularly limited, and examples thereof include electrical insulating films such as a polyimide film, a polyethylene terephthalate (PET) film, a polyethylene naphthalate (PEN) film, a polyester film, a poly (parabanic acid) film, a polyether ether ketone film, a polyphenylene sulfide film, an aramid film, a polycarbonate film, and a polyarylate film.

As the metal foil, metal foils used in common metal-clad laminates, wiring substrates and the like can be used without limitation, and examples thereof include copper foil and aluminum foil

In the stretchable laminate of the present embodiment, the thickness of the first substrate (B) may be appropriately set according to the application of the laminate, the type of the substrate, and the like, but for example, when the first substrate (B) is a resin (film) substrate, the thickness is preferably about 0.01 mm or more and 0.2 mm or less. From the viewpoint of handling, the thickness is more preferably 0.02 mm or more and 0.1 mm. When the first substrate (B) is a metal foil, the thickness thereof is preferably about 0.005 mm or more and 0.05 mm or less, and particularly from the viewpoint of securing the strength of a circuit and the flexibility of a circuit board, the thickness is more preferably 0.009 mm or more and 0.035 mm or less.

In addition, the thickness of the second substrate (C) may be similarly appropriately set, and for example, when the second substrate (C) is a resin (film) substrate, the thickness is preferably about 0.01 mm or more and 0.2 mm or less. From the viewpoint of handling, the thickness is more preferably 0.02 mm or more and 0.1 mm. When the second substrate (C) is a metal foil, the thickness is preferably about 0.005 mm or more and 0.05 mm or less, and particularly from the viewpoint of securing the strength of a circuit and the flexibility of a circuit board, the thickness is more preferably 0.009 mm or more and 0.035 mm or less. The thickness of the first substrate (B) and that of the second substrate (C) may be different or the same.

The peel strength between the first substrate (B) and the resin layer (A) and that between the second substrate (C) and the resin layer (A) are different in suitable range depending on the material (application) of each substrate. Some examples are provided as follows. When the first substrate (B) and the second substrate (C) are both films, the first substrate (B) is a support film (carrier), and the second substrate (C) is a release film (protective film, cover film, or the like), it is preferable that the peel strength between the first substrate (B) and the resin layer (A) is 4 mN/mm or more and 1000 mN/mm or less, the peel strength between the second substrate (C) and the resin layer (A) is 2 mN/mm or more and 700 mN/mm or less, and the peel strength between the first substrate (B) and the resin layer (A) is higher than the peel strength between the second substrate (C) and the resin layer (A).

Alternatively, when both the first substrate (B) and the second substrate (C) are metal foils, both the peel strength between the first substrate (B) and the resin layer (A) and the peel strength between the second substrate (C) and the resin layer (A) are preferably about 700 mN/mm or more and 5000 mN/mm or less. Further, when the first substrate (B) is a metal foil and the second substrate (C) is a release film (protective film, cover film, or the like), it is preferable that the peel strength between the first substrate (B) and the resin layer (A) is 700 mN/mm or more and 5000 mN/mm or less, the peel strength between the second substrate (C) and the resin layer (A) is 2 mN/mm or more and 700 mN/mm or less, and the peel strength between the first substrate (B) and the resin layer (A) is equivalent to the peel strength between the second substrate (C) and the resin layer (A).

### (Method for Manufacturing Stretchable Laminate)

Next, a method for manufacturing the stretchable laminate of the present embodiment will be described. The method for manufacturing a stretchable laminate of the present embodiment includes laminating the resin layer (A), the first substrate (B), and the second substrate (C), and heating these under pressurization, wherein a pressure during the pressurization is 0.3 MPa or more and 10 MPa or less.

Conventionally, it has been believed that bubbles and the like generated when a resin composition containing a radical polymerization initiator such as an organic peroxide is cured to produce a film or the like can be reduced by pressure molding. However, in the case of a material having flexibility or stretchability after curing, there is a problem that fluidity is high even at the time of molding, and loss due to resin flow is increased by pressure molding. The manufacturing method of the present embodiment has an advantage that a loss due to a resin flow can be inhibited in obtaining the stretchable laminate of the present embodiment.

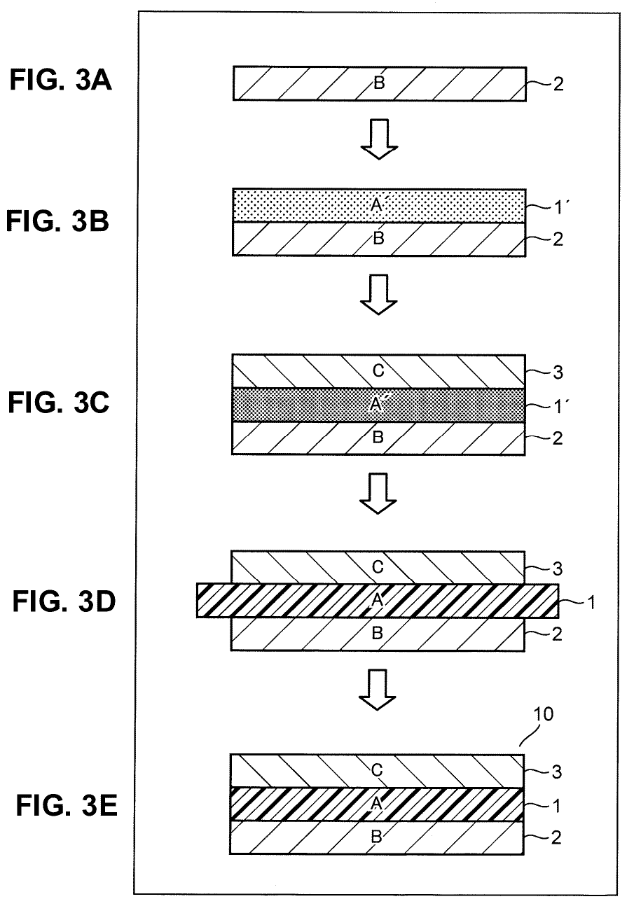

FIGS. 3A to 3E are views illustrating one embodiment of the manufacturing method of the present embodiment. First, as illustrated in FIG. 3A, a first substrate (B) is prepared. Next, as illustrated in FIG. 3B, a resin varnish of the resin composition to constitute the resin layer (A) is applied so as to have a desired thickness. Examples of the application method include a bar coater, a comma coater, a die coater, a roll coater, and a gravure coater.

Such a resin varnish is prepared, for example, as follows. First, the respective components that can be dissolved in an organic solvent, such as a resin component (an elastomer or the like) and an organic peroxide, are put into an organic solvent and dissolved. At this time, heating may be performed, as necessary. Thereafter, components (for example, inorganic filler) insoluble in the organic solvent are added, as necessary, and dispersed in the solution until a prescribed dispersion state is achieved using a ball mill, a bead mill, a planetary mixer, a roll mill or the like, whereby a varnish-like resin composition is prepared. The organic solvent to be used in the present embodiment is not particularly limited as long as it dissolves the styrenic copolymer, the organic peroxide, and the like and does not inhibit the curing reaction. Examples thereof specifically include toluene, methyl ethyl ketone, cyclohexanone and propylene glycol monomethyl ether acetate. These solvents may be used singly or two or more thereof may be used in combination. A part or all of the solvent may be replaced with a reactive diluent. Examples of the reactive diluent include styrene, butyl acrylate, butyl methacrylate, butyl glycidyl ether, and 1,2-dodecene.

Thereafter, the applied resin varnish is heated under desired heating conditions, for example, at 50° C. or higher and 180° C. or lower for about 1 minute or more and 60 minutes or less. By heating, the solvent is volatilized from the varnish and the solvent is diminished or removed to afford a resin layer (A′) before curing (in A stage) or in a semi-cured state (B stage).

Next, as illustrated in FIG. 3C, a second substrate (C) is laminated on the resin layer (A′). The lamination may be performed by a vacuum lamination method. Then, as illustrated in FIG. 3D, heat-pressure molding is performed to cure the resin layer (A′), and lamination and integration are performed to afford a stretchable laminate including the first substrate (B), the resin layer (A), and the second substrate (C). At this time, by sandwiching the resin layer (A′) between the first substrate (B) and the second substrate (C), performing heating and pressurization, and setting the pressure at the time of pressurization to 0.3 MPa or more and 10 MPa or less, generation of bubbles and openings in the resin layer (A) of the stretchable laminate of the present embodiment can be inhibited.

The temperature at the time of heating and pressurization is preferably set to about 130 to 230° C., and the heating and pressurization time may be about 5 to 120 minutes.

As illustrated in FIG. 3D, in performing the heat-pressure molding, the resin layer (A) may flow out of the first substrate (B) and the second substrate (C) as described above, so that resin loss may occur. The manufacturing method of the present embodiment has an advantage that the resin loss can be reduced by adjusting the temperature and the pressure at the time of pressurization into appropriate ranges.

The resin layer (A) squeezed-out is removed by cutting with a cutter, a slitter, a press-cutting machine, or the like, and thus a stretchable laminate can be obtained as illustrated in FIG. 3E.

The stretchable laminate of the present embodiment can be used for various applications. For example, when the stretchable laminate is used as a material of a stretchable electronic device, especially a stretchable circuit board, at least one of the first substrate (B) and the second substrate (C) may be a conductive layer such as a metal foil, or the first substrate (B) or the second substrate (C) may be peeled off and a conductive layer may be provided on the resin layer (A) using a conductive paste or the like.

### (Electronic Device)

The present embodiment also includes an electronic device in which an electronic component is further mounted on the stretchable laminate described above.

The electronic component that can be used in the present embodiment is not particularly limited, and examples thereof include wireless modules such as resistances, transistors, signal transmission elements, light emitting elements, solar power generation elements, diodes, switching elements, capacitors, coils, liquid crystals, and Bluetooth (registered trademark), various sensors such as acceleration sensors, humidity sensors, and temperature sensors, chip parts to be used for RFIDs and the like.

The electronic component can be mounted by, for example, a mounting method using a conductive pressure-sensitive adhesive or an adhesive or a mounting method using solder and reflow. In addition, it is also possible to print and form an element on the resin layer (A) of the stretchable laminate or a substrate instead of the solder.

This specification discloses techniques in various aspects as described above, and the main techniques among them are summarized below.

A stretchable laminate according to a first aspect of the present invention is a laminate including: a resin layer (A); a first substrate (B); and a second substrate (C), wherein the resin layer (A) includes a cured product of a resin composition including an organic peroxide, the resin layer (A) is located between the first substrate (B) and the second substrate (C), the resin layer (A) has a tensile stress of 0.5 MPa or more and 10 MPa or less at 50% elongation, and an elongation at break of 50% or more and 700% or less, and when a surface of the resin layer (A) is observed with an optical microscope, a total number of bubbles and openings having a diameter of 150 to 500 μm is 5 per 10 cm² or less, and bubbles and openings having a diameter exceeding 500 μm are not present.

In a stretchable laminate according to a second aspect, in the stretchable laminate according to the first aspect, the resin composition comprises an elastomer having a melting point of 70° C. or higher.

In a stretchable laminate according to a third aspect, in the stretchable laminate according to the second aspect, the elastomer comprises a styrenic copolymer.

In a stretchable laminate according to a fourth aspect, in the stretchable laminate according to the third aspect, the styrenic copolymer comprises at least one selected from the group consisting of a styrene butadiene styrene copolymer, a methylstyrene (ethylene/butylene) methylstyrene copolymer, a methylstyrene (ethylene-ethylene/propylene) methylstyrene copolymer, a styrene isoprene copolymer, a styrene isoprene styrene copolymer, a styrene (ethylene/butylene) styrene copolymer, a styrene ethylene copolymer, a styrene (ethylene-ethylene/propylene) styrene copolymer, a styrene (butadiene/butylene) styrene copolymer, a styrene isobutylene styrene copolymer, and hydrogenated products of these copolymers.

In a stretchable laminate according to a fifth aspect, in the stretchable laminate according to the third aspect, a blending ratio (mass ratio) of the styrenic copolymer to the organic peroxide in the resin composition is 99.9:0.1 to 95.0:5.0.

In a stretchable laminate according to a sixth aspect, in the stretchable laminate according to the second aspect, the resin composition comprises at least one resin selected from the group consisting of a polybutadiene resin, a polyphenylene ether resin, an epoxy resin, a maleimide resin, a polysiloxane resin, and an acrylic resin.

In a stretchable laminate according to a seventh aspect, in the stretchable laminate according to the sixth aspect, the resin composition comprises a polybutadiene resin, and a mass ratio of other resin components to the polybutadiene resin in the resin composition is 95.0:5.0 to 80.0:20.0.

In a stretchable laminate according to an eighth aspect, in the stretchable laminate according to any one the first to seventh aspects, the first substrate (B) has a melting point of 250° C. or higher.

In a stretchable laminate according to a ninth aspect, in the stretchable laminate according to any one of the first to eighth aspects, the second substrate (C) has a melting point of 250° C. or higher.

In a stretchable laminate according to a tenth aspect, in the stretchable laminate according to any one of the first to ninth aspects, a total number of bubbles and openings having a diameter of 150 to 500 μm on a surface of the resin layer (A) is 1 per 10 cm² or less.

In a stretchable laminate according to an eleventh aspect, in the stretchable laminate according to any one of the first to tenth aspects, the first substrate (B) is any one selected from among a polyimide film, a polyethylene terephthalate film, a polyethylene naphthalate film, an aluminum foil, and a copper foil.

In a stretchable laminate according to a twelfth aspect, in the stretchable laminate according to any one of the first to eleventh aspects, the second substrate (C) is any one selected from among a polyimide film, a polyethylene terephthalate film, a polyethylene naphthalate film, an aluminum foil, and a copper foil.

A stretchable laminate according to a thirteenth aspect is the stretchable laminate according to any one of the first to twelfth aspects for a stretchable electronic device.

A stretchable laminate according to a fourteenth aspect is the stretchable laminate according to the thirteenth aspect having a circuit pattern.

A method for manufacturing a stretchable laminate according to a fifteenth aspect is a method for manufacturing the stretchable laminate according to any one of the first to fourteenth aspects, the method including: laminating the resin layer (A), the first substrate (B), and the second substrate (C), and heating these under pressurization, wherein a pressure during the pressurization is 0.3 MPa or more and 10 MPa or less.

An electronic device according to a sixteenth aspect includes: the stretchable laminate according to any one of the first to fourteenth aspects; and an electronic component.

Hereinafter, the present invention will be described more specifically with reference to Examples, but the scope of the present invention is not limited thereto.

### EXAMPLES

First, all kinds of materials used in the present Examples are as follows.

### <Elastomer>

Styrenic copolymer 1: Hydrogenated (partially hydrogenated) styrenic thermoplastic elastomer (SEBS), “Tuftec (registered trademark) P1083” (manufactured by Asahi Kasei Corporation)
Styrenic copolymer 2: Styrene-isoprene-styrene (SIS) block copolymer, “HYBRAR (registered trademark) 5125” (manufactured by Kuraray Co., Ltd.)
Styrenic copolymer 3: Polystyrene (unhydrogenated), “Kraton (registered trademark) D1101” (manufactured by Kraton Corporation)
Styrenic copolymer 4: Hydrogenated (completely hydrogenated) styrenic thermoplastic elastomer (SEBS) (“Tuftec (registered trademark) H1062” (manufactured by Asahi Kasei Corporation)
Other polymers: Liquid polybutadiene, “B2000” (manufactured by Nippon Soda Co., Ltd.)

### <Organic Peroxide>

Organic peroxide 1: (1,3-Bis(butylperoxyisopropyl)benzene; “PERBUTYL (registered trademark) P” (manufactured by NOF Corporation)
Organic peroxide 2:1,1-Di(t-hexylperoxy)cyclohexane, “PERHEXA (registered trademark) HC” (manufactured by NOF Corporation)

### <First Substrate (B) and Second Substrate (C)>

Release film 1: Polyethylene naphthalate (PEN) film (melting point: 268° C., thickness: 75 μm)
Release film 2: Polyethylene terephthalate (PET) film (melting point: 255° C., thickness: 75 μm)
Release film 3: Polyimide (PI) film (melting point: higher than 400° C., thickness: 50 μm)
Copper foil (“CF-T9DA-SV” manufactured by Fukuda Metal Foil & Powder Co., Ltd., melting point: higher than 1000° C., copper foil thickness: 18 μm)

### <Preparation of Resin Varnish>

### Examples 1 to 11 and Comparative Examples 1 to 3

First, an elastomer as a base material was dissolved in toluene so as to have a solid concentration of 35% by mass, and then an organic peroxide was blended and mixed at a blending ratio (parts by mass) given in Table 1 described later, thereby affording a resin varnish of each Example and Comparative Example.

### <Preparation of Sample for Evaluation>

### Examples 1 to 4, 6 to 7, 9

Using release film 1 as the first substrate (B), the resin varnish of each Example was applied thereon such that the thickness after drying was 100 μm, and dried at 80° C. for 10 minutes to form an uncured resin layer. Subsequently, release film 1 as the second substrate (C) was laminated on the resin layer, and vacuum lamination (vacuum time: 20 seconds, pressure: 0.3 MPa, pressurization time: 1 minute, temperature: 80° C.) was performed. Thereafter, the resin layer was cured by heating and pressurization under the conditions of a temperature of 180° C. and a pressure of 4 MPa for 30 minutes, affording a stretchable laminate in which the first substrate (B), the resin layer (A) and the second substrate (C) were laminated.

### Example 5

A stretchable laminate was obtained in the same manner as in Example 1 except that the resin varnish of Example 5 was used and the pressure at the time of heating and pressurization was changed to 10 MPa.

### Example 8

A stretchable laminate was obtained in the same manner as in Example 1 except that the resin varnish of Example 8 was used, release film 2 was used as the first substrate (B) and the second substrate (C), and the conditions for heating and pressurization were changed to a temperature of 130° C. and a pressure of 0.3 MPa.

### Example 10

A stretchable laminate was obtained in the same manner as in Example 1 except that the resin varnish of Example 10 was used, release film 3 was used as the first substrate (B) and the second substrate (C), and the temperature during heating and pressurization was changed to 220° C.

### Example 11

A stretchable laminate was obtained in the same manner as in Example 1 except that the resin varnish of Example 11 was used and a copper foil was used as the first substrate (B) and the second substrate (C).

### Comparative Example 1

The resin varnish of Comparative Example 1 was used, and release film 1 was used as the second substrate (C). Since the first substrate (B) was not used, pressurization could not be performed, and only heating was performed at 180° C. for 30 minutes. However, the resin layer was not sufficiently cured and was melted, and a stretchable laminate could not be obtained.

### Comparative Example 2

A laminate was obtained in the same manner as Example 1 except that the resin varnish of Comparative Example 2 was used, release film 1 was used as the first substrate (B) and the second substrate (C), and the pressure during heating and pressurization was 0.1 MPa.

### Comparative Example 3

Heating and pressurization were performed in the same manner as in Example 1 except that the resin varnish (including no organic peroxide) of Comparative Example 3 was used, but a resin layer was not sufficiently cured and was melted, and a stretchable laminate could not be obtained.

### Reference Example

A laminate was obtained in the same manner as in Example 1 except that the resin varnish of Reference Example was used.

| | | Example 1 | Example 2 | Example 3 | Example 4 | Example 5 | Example 6 | Example 7 | Example 8 |
|---|---|---|---|---|---|---|---|---|---|
| Base | Styrenic | 98 | 99.5 | 97 | 95 | 95 | 89 | | |
| material | copolymer 1 | | | | | | | | |
| | Styrenic | | | | | | | 99.5 | 98.5 |
| | copolymer 2 | | | | | | | | |
| | Styrenic | | | | | | | | |
| | copolymer 3 | | | | | | | | |
| | Styrenic | | | | | | | | |
| | copolymer 4 | | | | | | | | |
| | Other | | | | | | 9 | | |
| | Polymers | | | | | | | | |
| Organic | Organic | 2 | 0.5 | 3 | 5 | 5 | 2 | 0.5 | |
| peroxide | peroxide 1 | | | | | | | | |
| | Organic | | | | | | | | 1.5 |
| | peroxide 2 | | | | | | | | |

| First substrate (B) | Release | Release | Release | Release | Release | Release | Release | Release |
|---|---|---|---|---|---|---|---|---|
| | film 1 | film 1 | film 1 | film 1 | film 1 | film 1 | film 1 | film 2 |
| Second substrate (C) | Release | Release | Release | Release | Release | Release | Release | Release |
| | film 1 | film 1 | film 1 | film 1 | film 1 | film 1 | film 1 | film 2 |
| Curing conditions | 180° C. | 180° C. | 180° C. | 180° C. | 180° C. | 180° C. | 180° C. | 130° C. |
| | 30 min | 30 min | 30 min | 30 min | 30 min | 30 min | 30 min | 30 min |
| | 4 MPa | 4 MPa | 4 MPa | 4 MPa | 10 MPa | 4 MPa | 4 MPa | 0.3 MPa |

| | | | | | Comparative | Comparative | Comparative | Reference |
|---|---|---|---|---|---|---|---|---|
| | | Example 9 | Example 10 | Example 11 | Example 1 | Example 2 | Example 3 | Example |
| Base | Styrenic | | | 98 | 98 | 98 | 100 | 69 |
| material | copolymer 1 | | | | | | | |
| | Styrenic | | | | | | | |
| | copolymer 2 | | | | | | | |
| | Styrenic | 99.5 | | | | | | |
| | copolymer 3 | | | | | | | |
| | Styrenic | | 99.5 | | | | | |
| | copolymer 4 | | | | | | | |
| | Other | | | | | | | 29 |
| | Polymers | | | | | | | |
| Organic | Organic | 0.5 | 0.5 | 2 | 2 | 2 | | 2 |
| peroxide | peroxide 1 | | | | | | | |
| | Organic | | | | | | | |
| | peroxide 2 | | | | | | | |

| First substrate (B) | Release | Release | Copper | None | Release | Release | Release |
|---|---|---|---|---|---|---|---|
| | film 1 | film 3 | foil | | film 1 | film 1 | film 1 |
| Second substrate (C) | Release | Release | Copper | Release | Release | Release | Release |
| | film 1 | film 3 | foil | film 1 | film 1 | film 1 | film 1 |
| Curing conditions | 180° C. | 220° C. | 180° C. | 180° C. | 180° C. | 180° C. | 180° C. |
| | 30 min | 30 min | 30 min | 30 min | 30 min | 30 min | 30 min |
| | 4 MPa | 4 MPa | 4 MPa | No | 0.1 MPa | 4 MPa | 4 MPa |
| | | | | pressure | | | |

### <Evaluation Test>

### (Melting Point of Base Material)

The base material component was dissolved in toluene, applied onto a release film so that the thickness after drying was 100 μm, and then dried at 110° C. for 10 minutes, affording a base material film. This film was cut into a rectangle, the release film was peeled off, and the resultant was subjected to dynamic mechanical analysis (DMA) at a sine wave frequency of 10 Hz at a temperature raising rate of 5° C. per minute. The intersection of the tangent of the storage elastic modulus of a rubber-like region and the tangent of the storage elastic modulus at melting was defined as a melting point.

### (Heat Resistance)

Only a resin layer (A) was attached to a clip and suspended in an oven at 180° C. for 30 minutes, and then the shape was observed. The evaluation criteria are as follows.

Pass: The resin layer was not melted.

Fail: The resin layer was melted.

### (Tensile Stress at 50% Elongation and Elongation at Break)

First, a test piece was prepared. Specifically, size 6 dumbbell test pieces specified in JIS K 6251 were taken from the cured resin layers obtained in Examples 1 to 11 and Comparative Example 2. In Comparative Examples 1 and 3, since the resin layer was melted and not cured, a test piece could not be taken.

Next, each of the obtained test pieces was subjected to a tensile test under the following conditions using an Autograph (AGS-X) manufactured by Shimadzu Corporation.
Load cell: 50N
Initial distance between grippers: 35 mm
Tensile speed: 25 mm/min

As the tensile stress (MPa) at 50% elongation, the stress at the time when the stroke reached 17.5 mm was measured.
Stress=F/(d·l) (F is test force, d is film thickness, and l is width of test piece)

The elongation at break (%) of the film was calculated by the following equation using the moving distance of the gripper at the time of fracture.
Percentage elongation after fracture (%) of film=x/35×100

In this evaluation test, a range of the tensile stress of 1 MPa or more and 10 MPa or less is regarded as pass. In addition, an elongation at break (%) of 50% or more is regarded as pass.

### (Long-Term Heat Resistance)

A laminate was placed in an oven at 120° C. and aged for 50 hours, and the stress at 50% elongation before and after the heating was measured to determine the amount of change in stress.

The evaluation criteria are as follows.
Very good: The amount of change in 50% stress is 30% or less.
Good: The amount of change in 50% stress is 50% or less.
Normal: The amount of change in 50% stress is more than 50%.

### (Bubbles and Openings)

The case Where the Substrate (C) is a Film

The laminate sample was cut into a size of 2 cm×5 cm, the second substrate (C) was peeled off, the resultant was magnified 10 times with an optical microscope, the surface of the resin layer (A) was observed from the observation direction indicated by the arrow in FIG. 2, and the number and size of bubbles and openings were measured. Since it was difficult to distinguish between bubbles and openings, their total number was counted.

### The Case Where the Substrate (C) is a Metal Foil.

After the metal foil was removed by etching, the number and size of bubbles and openings were measured in the same manner as described above. As to the number, the number of bubbles and openings existing in any 10 cm² area on the surface of the resin layer was measured.

In both the cases, the acceptance criterion is that the total number of bubbles and openings having a diameter of 150 to 500 μm is 5 per 10 cm² or less.

### (Presence or Absence of Pinholes in Case of Forming Conductive Layer)

### The Case Where the Substrate (C) is a Film

The laminate sample was cut into a size of 2 cm×5 cm, the second substrate (C) was peeled off, and a silver paste “LS-453-6B” (manufactured by Asahi Chemical Laboratory Co., Ltd.) was screen-printed on the resultant and dried at 80° C. for 30 minutes to form a 10 μm conductive layer. Thereafter, the number and size of pinholes on the conductive layer were measured in the same manner as in the measurement of bubbles and openings.

### The Case Where the Substrate (C) is a Metal Foil.

The surface of the laminate was observed with the metal foil attached, and the number and size of pinholes on the metal foil were measured in the same manner as in the measurement of bubbles and openings. As to the number, the number of bubbles and openings existing in any 10 cm² area on the surface of the resin layer was measured.

In both the cases, the acceptance criterion is that the total number of bubbles and openings having a diameter of 150 to 500 μm is 5 per 10 cm² or less.

### (Resin Loss (%))

The laminate before curing cut into a 10 cm square was heat-press-molded under the curing conditions described in Table 1. Thereafter, the resin squeezed-out from the substrate layer was cut out with a cutter, and the weight (W1) thereof was measured. Next, the substrate (B) and the substrate (C) were peeled off, and the weight (W2) of the resin layer that had been sandwiched between the substrates was measured. The resin loss was calculated by the following equation. In a case where the resin flows without being cured, it becomes impossible to perform measurement, and thus, it is described as unmeasurable.

$$Resin loss ( \% ) = W 1 / ( W 1 + W 2 ) \times 100$$

The results are summarized in Table 2.

| | | Exam- | Exam- | Exam- | Exam- | Exam- | Exam- | Exam- | Exam- |
|---|---|---|---|---|---|---|---|---|---|
| | | ple 1 | ple 2 | ple 3 | ple 4 | ple 5 | ple 6 | ple 7 | ple 8 |
| Evaluation | Melting point | 90 | 90 | 90 | 90 | 90 | 82 | 110 | 110 |
| | (DMA) of | | | | | | | | |
| | base material | | | | | | | | |
| | Heat resistance | Pass | Pass | Pass | Pass | Pass | Pass | Pass | Pass |
| | 50% Stress/ | 2.0 MPa/ | 1.7 MPa/ | 2.7 MPa/ | 5.5 MPa/ | 5.5 MPa/ | 3.3 MPa/ | 2.7 MPa/ | 2.7 MPa/ |
| | Percentage | 291% | 680% | 200% | 60% | 60% | 152% | 253% | 276% |
| | elongation after | | | | | | | | |
| | fracture | | | | | | | | |
| | Long-term heat | Very | Very | Very | Very | Very | Good | Normal | Normal |
| | resistance | good | good | good | good | good | | | |
| | Bubble and | 0 | 0 | 1/250 μm | 5/450 μm | 1/150 μm | 0 | 0 | 0 |
| | opening | | | | | | | | |
| | Pinhole | 0 | 0 | 0 | 2/150 μm | 0 | 0 | 0 | 0 |
| | Resin loss (%) | 10 | 12 | 6 | 5 | 25 | 11 | 12 | 1 |

| | | | | | Compar- | Compar- | Compar- | |
|---|---|---|---|---|---|---|---|---|
| | | | | | ative | ative | ative | |
| | | Exam- | Exam- | Exam- | Exam- | Exam- | Exam- | Reference |
| | | ple 9 | ple 10 | ple 11 | ple 1 | ple 2 | ple 3 | Example |
| Evaluation | Melting point | 93 | 76 | 90 | 90 | 90 | 90 | 80 |
| | (DMA) of | | | | | | | |
| | base material | | | | | | | |
| | Heat resistance | Pass | Pass | Pass | Fail | Pass | Fail | Pass |
| | 50% Stress/ | 2.3 MPa/ | 1.5 MPa/ | 1.9 MPa/ | — | — | — | — |
| | Percentage | 83% | 430% | 354% | | | | |
| | elongation after | | | | | | | |
| | fracture | | | | | | | |
| | Long-term heat | Normal | Very | Very | — | — | — | — |
| | resistance | | good | good | | | | |
| | Bubble and | 0 | 5/400 μm | 1/150 μm | 0 | 15/550 μm | 0 | — |
| | opening | | | | | | | |
| | Pinhole | 0 | 1/150 μm | 0 | — | 3/200 μm | 0 | — |
| | Resin loss (%) | 5 | 23 | 10 | 25 | 3 | Unmea- | >90 |
| | | | | | | | surable | |

### (Discussion)

As is apparent from the results disclosed in Table 2, the stretchable laminate of the present embodiment was a stretchable laminate having flexibility and stretchability and having a resin layer with reduced bubbles and openings. In addition, it was confirmed that the stretchable laminate of the present embodiment was also superior in heat resistance and long-term heat resistance. In this test, it was found that bubbles and openings due to outgas can be reduced depending on the amount of an organic peroxide and the conditions at the time of heating and pressurization for curing the resin layer.

On the other hand, in Comparative Example 1 in which the second substrate (C) was not used and Comparative Example 3 in which the organic peroxide was not added, the resin layer (A) could not be sufficiently cured. In addition, in Comparative Example 2 in which the pressure at the time of heating and pressurization was excessively low, bubbles and openings having a large size were generated, and as a result, pinholes were generated in the conductive layer.

As shown in Table 2, it was confirmed that the loss of the resin can be reduced by increasing the amount of the organic peroxide under the same curing conditions as in Examples 1 to 4. On the other hand, it was also found that when the pressure was increased as in Examples 4 and 5, the resin loss tended to increase. In Example 8, due to the selection of the organic peroxide, lower-temperature curing and a lower pressure were possible as compared with Example 7 which is common in the base material, and the loss of the resin could be reduced. In Example 10, the reactivity of the base material was good and the resin loss was small as compared with Example 2. In Example 11, the reactivity of the base material was poor as compared with Example 1, and it was necessary to set the temperature to a higher temperature, and as a result of the drop of the resin viscosity, the amount of the loss of the resin was increased. In Comparative Example 1, since curing did not proceed, much resin flowed out. In Comparative Example 3, since pressure was applied in the absence of an organic peroxide, the resin loss was noticeable and could not be measured. In Comparative Example 2, the resin loss can be reduced at a very low pressure, but generation of bubbles was noticeable. As described above, it has also been confirmed that a stretchable laminate can be obtained while inhibiting the resin loss by controlling the temperature and pressure conditions.

It is noted that in the laminate of Reference Example, since resin flow occurred and the resin loss was large, only the evaluation of heat resistance could be performed.

This application is based on Japanese Application No. 2023-174651 filed in the Japanese Patent Office on Oct. 6, 2023, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A stretchable laminate comprising:
a resin layer (A);
a first substrate (B); and
a second substrate (C),
wherein the resin layer (A) includes a cured product of a resin composition including an organic peroxide,
the resin layer (A) is located between the first substrate (B) and the second substrate (C),
the resin layer (A) has a tensile stress of 0.5 MPa or more and 10 MPa or less at 50% elongation, and an elongation at break of 50% or more and 700% or less, and
when a surface of the resin layer (A) is observed with an optical microscope, a total number of bubbles and openings having a diameter of 150 to 500 μm is 5 per 10 cm² or less, and bubbles and openings having a diameter exceeding 500 μm are not present.

2. The stretchable laminate according to claim 1, wherein the resin composition comprises an elastomer having a melting point of 70° C. or higher.

3. The stretchable laminate according to claim 2, wherein the elastomer comprises a styrenic copolymer.

4. The stretchable laminate according to claim 3, wherein the styrenic copolymer comprises at least one selected from the group consisting of a styrene butadiene styrene copolymer, a methylstyrene (ethylene/butylene) methylstyrene copolymer, a methylstyrene (ethylene-ethylene/propylene) methylstyrene copolymer, a styrene isoprene copolymer, a styrene isoprene styrene copolymer, a styrene (ethylene/butylene) styrene copolymer, a styrene ethylene copolymer, a styrene (ethylene-ethylene/propylene) styrene copolymer, a styrene (butadiene/butylene) styrene copolymer, a styrene isobutylene styrene copolymer, and hydrogenated products of these copolymers.

5. The stretchable laminate according to claim 3, wherein a mass ratio of the styrenic copolymer to the organic peroxide in the resin composition is 99.5:0.5 to 95.0:5.0.

6. The stretchable laminate according to claim 2, wherein the resin composition comprises at least one resin selected from the group consisting of a polybutadiene resin, a polyphenylene ether resin, an epoxy resin, a maleimide resin, a polysiloxane resin, and an acrylic resin.

7. The stretchable laminate according to claim 6, wherein the resin composition comprises a polybutadiene resin, and a mass ratio of other resin components to the polybutadiene resin in the resin composition is 95.0:5.0 to 80.0:20.0.

8. The stretchable laminate according to claim 1, wherein the first substrate (B) has a melting point of 250° C. or higher.

9. The stretchable laminate according to claim 1, wherein the second substrate (C) has a melting point of 250° C. or higher.

10. The stretchable laminate according to claim 1, wherein a total number of bubbles and openings having a diameter of 150 to 500 μm on a surface of the resin layer (A) is 1 per 10 cm² or less.

11. The stretchable laminate according to claim 1, wherein the first substrate (B) is any one selected from among a polyimide film, a polyethylene terephthalate film, a polyethylene naphthalate film, an aluminum foil, and a copper foil.

12. The stretchable laminate according to claim 1, wherein the second substrate (C) is any one selected from among a polyimide film, a polyethylene terephthalate film, a polyethylene naphthalate film, an aluminum foil, and a copper foil.

13. The stretchable laminate according to claim 1, wherein the stretchable laminate is for a stretchable electronic device.

14. The stretchable laminate according to claim 13, comprising a circuit pattern.

15. A method for manufacturing the stretchable laminate according to claim 1, the method comprising:
laminating the resin layer (A), the first substrate (B), and the second substrate (C), and heating these under pressurization,
wherein a pressure during the pressurization is 0.3 MPa or more and 10 MPa or less.

16. An electronic device comprising:
the stretchable laminate according to claim 1; and
an electronic component.
